(19) United States
(12) Patent Application Publication
(10) Pub. No.: US 2015/0130287 A1
(43) Pub. Date: May 14, 2015

(54) METHOD AND APPARATUS FOR CONTACTLESS TRANSMISSION OF ELECTRICAL ENERGY BETWEEN A WALL AND A DOOR LEAF/WINDOW SASH FASTENED TO THIS WALL

(71) Applicants: Joachim Steudtner, Selbitz (DE); Christian Rost, Naila (DE)

(72) Inventors: Joachim Steudtner, Selbitz (DE); Christian Rost, Naila (DE)

(73) Assignee: DR. HAHN GMBH & CO. KG, Moenchengladbach-Wickrath (DE)

(21) Appl. No.: 14/117,038

(22) PCT Filed: Sep. 29, 2011
(86) PCT No.: PCT/EP2011/067020

§ 371 Date: Nov. 12, 2013

(30) Foreign Application Priority Data
May 13, 2011 (DE) 10 2011 050 342.0

(51) Int. Cl. H02J 5/00; E05D 7/00; E05F 15/00; H02J 17/00; E06B 7/28

(52) U.S. Cl. CPC H02J 5/005; H02J 17/00; E06B 7/28; E05F 15/00; E05D 7/00
USPC 307/104

(57) ABSTRACT

A method to transmit electrical energy between a wall and a door leaf fastened to the wall includes providing a primary power coil and a secondary power coil which are in an inductive operative connection. An electrical primary current flowing through the primary power coil is measured to obtain a measured value. The measured value is supplied to a primary power electronics device which stores a transmission characteristic as a function of a power available at the secondary power coil in dependence on a primary power supplied to the primary power coil. A maximum provided power is applied to the primary power coil when an electrical primary current increases. A secondary power voltage induced in the secondary power coil is limited to a preset maximum value. A primary current is measured and, based thereon, a power applied to the primary power coil is reduced until a required power is induced.

### CROSS REFERENCE TO PRIOR APPLICATIONS

This application is a U.S. National Phase application under 35 U.S.C. §371 of International Application No. PCT/EP2011/067020, filed on Sep. 29, 2011 and which claims benefit to German Patent Application No. 10 2011 050 342.0, filed on May 13, 2011. The International Application was published in German on Nov. 22, 2012 as WO 2012/155996 A1 under PCT Article 21(2).

### FIELD

The present invention relates to a method and apparatus for contactless transmission of electrical energy between a wall and a door leaf/window sash fastened to the wall in an articulated fashion using hinges about a hinge axis, in which a primary power coil fastened to the wall and a secondary power coil fastened to the leaf/sash are provided that form an inductive operative connection with the aid of a hinge bolt.

### BACKGROUND

The leaves and sashes of doors and windows on real properties such as houses, business premises or production facilities increasingly include means that improve safety and comfort, and any given current operating state of which is monitored or actuated from outside of the door/window, and any changes related to the operating state or any signals that may have been received from the sensors are transmitted to the monitoring or actuating means.

Reference is made, for example, to a burglar alarm system that is installed in a building and communicates with means that are provided on the door/window for monitoring, for example, access, breach, closure, tampering or a motor-driven lock to a facility.

Multi-wire cables are used in the prior art for transmitting the corresponding signals and to provide electrical conducting lines between the monitoring means and the means disposed on the door/window, which are flexibly routed between the door leaf/window sash and often provided with a flexible metal hose for protection.

These cable transitions considerably compromise the optical appearance and can become jammed in the door or window when the door leaf/window sash is closed, resulting in damage or even destruction of the cables. The cable transitions are furthermore points of vulnerability in terms of possible tampering, which is why so-called Z-wiring of the sensors or contacts is also implemented in the cable transition to protect against sabotage.

DE 10 2004 017 341 A1 describes a flap hinge with a transformer incorporated therein to provide a contactless energy transmission. This flap hinge comprises a primary coil that is disposed in a part of the frame of the flap hinge and a secondary coil that is disposed in a part of the leaf/sash of the hinge flap. Serving as a magnetic coupling for the secondary coil with the primary coil, which are disposed at a distance relative to each other in the direction of the hinge axis, is a ferrite core that traverses both coils and constitutes, simultaneously, the hinge bolt.

While this apparatus in principle allows for the contactless transmission of electrical energy and/or electrical signals between a wall and a leaf/sash that is fastened to this wall, providing power to the secondary side in a manner that is at least almost without delay, which is required, for example, for powering a motor with a sudden power demand, is not possible with this apparatus.

### SUMMARY

An aspect of the present invention is to provide a method that is improved in this regard, as well as an apparatus for the implementation of this method, that provides for the contactless transmission of electrical energy between a wall and a door leaf/window sash, which is fastened to the wall, and that provides a first coil, which is fastened to the wall, and a second coil, which is fastened to the leaf/sash, that together form an inductive operative connection.

In an embodiment, the present invention provides a method for a contactless transmission of electrical energy between a wall and a door leaf/window sash fastened to the wall in an articulated fashion via hinges about a hinge axis which includes providing a primary power coil fastened to the wall, providing a secondary power coil fastened to the door leaf/window sash. The primary power coil and the secondary power coil are configured to be in an inductive operative connection with each other. An electrical primary current flowing through the primary power coil is measured so as to obtain a measured value. The measured value is supplied to a primary power electronics device which is configured to store a transmission characteristic as a function of a power available at the secondary power coil in dependence on a primary power supplied to the primary power coil. A maximum provided power is applied to the primary power coil when an electrical primary current increases. A secondary power voltage induced in the secondary power coil is limited to a preset maximum value. A primary current is measured and, based on the measured primary current, a power applied to the primary power coil is reduced until a required power, which is stored according to the transmission characteristic of the secondary power coil in the primary power electronics device, is induced

In an embodiment, the present invention also provides an apparatus for a contactless transmission of electrical energy between a wall and a leaf/sash fastened to the wall in an articulated fashion via hinges about a hinge axis which includes a primary power coil configured to be fastened to the wall, a secondary power coil configured to be fastened to the leaf/sash, a primary power electronics device configured to store a transmission characteristic as a function of a power available at the secondary power coil in dependence on a primary power supplied to the primary power coil, a current measuring device configured to measure a current that flows in the primary power coil so as to obtain a measured value which is suppliable to the primary power electronics device, a primary power influencing device configured to influence the primary power applied to the primary power coil, and a voltage-limiting device configured to limit a secondary voltage value generated by induction in the secondary power coil to a preset maximum voltage value

### BRIEF DESCRIPTION OF THE DRAWINGS

The present invention is described in greater detail below on the basis of embodiments and of the drawings in which:

FIG. 1 shows a schematic representation of the apparatus according to the present invention, shown as partially exposed, of the hinge flap and leaf/sash parts, seen in a perspective view and with schematically indicated primary and secondary electronics means;

FIG. 2 shows another schematic representation of the apparatus according to FIG. 1, shown in a mounted state on a frame profile and leaf/sash profile, which is fastened with the frame in an articulated fashion using hinges about a hinge axis;

FIG. 3 shows an overview representation of a functional block diagram of the apparatus;

FIG. 4 shows a representation of a functional block diagram of the primary electronics means of the apparatus on the frame side;

FIG. 5 shows a representation of a functional block diagram of the secondary electronics means on the leaf/sash side of the present apparatus;

FIG. 6 shows a representation of a longitudinal section through the hinge axis S of an embodiment of an apparatus according to the present invention that has the simultaneous function of a conventional hinge flap;

FIG. 7 shows a representation of the leaf/sash component of the present embodiment, seen in a perspective view by single parts thereof, also comprising depictions of the coils that are provided in the frame hinge flap part;

FIG. 8 shows a representation of a functional block diagram of the primary power electronics means as provided by an embodiment on the frame side; and

FIG. 9 shows a representation of a functional block diagram of the secondary power electronics means on the leaf/sash side of an embodiment.

### DETAILED DESCRIPTION

The method according to the present invention provides that the primary current that flows through the primary power coil is measured, and that the measured value is supplied to a primary power electronics means. The primary power electronics means includes a data storage unit where the transmission characteristic between the primary power coil and the secondary power coil is stored, meaning the power in form of a function of the power available at the secondary power coil in dependence on the primary power supplied to the primary power coil. Based on this transmission characteristic, it is known what power is needed on the primary side to achieve a certain power on the secondary side.

If no electrical power is needed on the secondary side, in other words, if there is no closed electrical circuit on the secondary side, only leakage current is measured on the primary side. Due to the fact that the transmission characteristic is deposited in the primary power electronics means, the voltage that is present at the open ends of the secondary circuit is known to the electronics means.

If the power demand suddenly increases on the secondary side, for example because a motor drive must be supplied with electrical power in order to trigger a function, this will result in an increase of the primary current. When the primary power electronic means detects this power demand, it triggers, for example, an AC-DC inverter, which can comprise a switching controller and/or a pulse width modulator, such that maximum power is applied to the primary power coil almost without delay. This can occur, for example, by applying the maximum allowable primary voltage and the maximum pulse width of the primary power voltage that can, for example, be provided as rectangular alternating voltage with a frequency of 40 kHz.

To prevent the consumer on the secondary side from exceeding the maximum allowable secondary voltage, a voltage-limiting means is provided on the secondary side by which the secondary voltage value that is generated in the secondary power coil is limited to the maximum voltage value. This step provides that only the electrical current that is actually needed flows on the secondary side, and therefore also on the primary side. Based on the measured primary current, the primary power electronics means now controls the power that is applied to the primary power coil downward until the required power, which is needed on the secondary side according to the stored transmission characteristic, must be present. The primary power therein can, for example, be adjusted by regulating the voltage in four steps and by a gradual regulation of the pulse width.

Based on knowledge of the transmission characteristic, the secondary power is known if a certain previously known relationship between primary voltage and pulse width applies. In that case, a certain, previously known primary power current, must be flowing.

If the measured primary current has a lower value than the expected current value, the provided power is too great, and the secondary power is reduced by the voltage-limiting means.

If the measured primary current value is higher, the provided power is too low. The primary power electronics means then increases the provided primary power by increasing the voltage and/or the pulse width according to the stored characteristic.

The apparatus according to the present invention for contactless transmission of electrical energy between a wall and a door leaf/window sash fastened to this wall in articulated fashion using hinges about a hinge axis comprises a primary power coil, which can be fastened to the wall, and a secondary power coil, which can be fastened the door leaf/window sash. A hinge bolt can serve as conducting body for the magnetic flow between the primary power coil and the secondary power coil.

According to the present invention, a primary power electronics means is provided where a transmission characteristic can be stored in the form of a function of the power available at the secondary power coil in dependence on the primary power supplied to the primary power coil. Further provided is a means for measuring the electrical primary current that flows through the primary power coil, and by which the corresponding measured value can be supplied to the primary power electronics means. A means is finally provided for influencing the primary power, which can, for example, include a switching controller and/or a pulse width modulator. A voltage-limiting means is provided on the secondary side that limits the secondary voltage value, which is generated in the secondary power coil due to induction, is limited to a preset maximum voltage value.

It is additionally possible to provide a rectifier that converts the secondary power voltage, which is induced in the secondary coil, into direct voltage.

The primary power electronics means can moreover comprise an AC-DC inverter. The apparatus is then suited for connection with a direct voltage source on the wall-side, for example, on a direct current output of an emergency-power-buffered power pack of an alarm system.

The primary power electronics means can comprise a low-pass filter for the purpose of filtering out interference frequencies in order to improve the operational reliability.

If the apparatus according to the present invention provides that the primary and secondary power coils also serve for transmitting bidirectional signals or data, or if separate first and second coils are available for this purpose, it is possible to apply at least one first control signal in a certain time interval to the primary power coil or the first coil and the at least one first signal, which is induced in the secondary power coil or second coil, can be detected.

At least one second control signal is furthermore applied to the second coil in the aforementioned time interval and the at least one second signal, which is induced in the first coil, is also detected. If, in this bidirectional signal transmission, not at least a part of the expected control signals is applied to a coil, or if not at least a part of the, due to the control signals, expected induced signals is detected in the coils, an alarm and/or disruption signal is generated. If this signal is transmitted, for example, to a danger reporting system in order to trigger an alarm, the method according to the present invention provides substantially improved protection against tampering and sabotage. The alarm and/or disruption signal can, however, also be routed to a so-called “watch dog” to avoid triggering false alarms in the event of disruptions for technical reasons.

Any reference below to the “first” and “second” coil relates, alternately also to the primary and/or secondary power coils.

Experimental studies have shown that, in single cases, signal disruptions can occur in the context of the bidirectional transmission and detection of control signals. To avoid that such disruptions result in the triggering of an alarm, two control signals can, for example, be applied each to the first and the second coil within the time interval. The disruption signal is only generated when both control signals or both induced, second signals are not applied or not detected. In other words, an disruption signal is not triggered until two consecutive control signal cycles have been identified as malfunctioning.

In an embodiment of the method of the present invention, a response control signal is applied to the first of the second coil after the induced signal has been generated, and the response control signal in turn generates an induced signal in the respective other coil.

The time interval during which signals that are correlated with each other are generated or detected can, for example, last between 10 ms and 500 ms, for example, approximately 60 ms.

A control signal and an associated response control signal can, for example, be generated within a time period of 20 ms to 100 ms, for example, approximately 40 ms.

The control signal can be a signal of any kind that allows for generating a signal in the respective other coil in an inductive manner. The control signal and, for example, also the response control signal can, for example, be generated by modulating a carrier voltage. Any signal modulation method that is known in the art is basically conceivable for use. For bidirectional transmission, the control signal can, for example, modulate the carrier voltage in terms of the amplitude, while the response control signal is frequency-modulated. The control signal can, for example, be generated on the side of the leaf/sash, and the response control signal can, for example, be generated on the side of the wall.

The carrier frequency of the carrier voltage depends on the design of the coil system. If a coil system with housings and cores is involved comprising MnZn ferrite, it is possible to use (depending on the MnZn material) carrier frequencies of 20 kHz to 2 MHz. Employing air coils is basically conceivable as well. The carrier frequencies can be greater in that case.

To increase protection even in the defense against complex tampering methods that involve, for example, inductive coupling of a sabotage coil with the first coil instead of the second coil that is provided on the leaf/window sash, an improvement of the method envisions querying a value of a control resistance, which is disposed on the leaf/sash side, within the time interval. A reporting group on the side of the leaf/sash is able to limit and digitize the control resistance value as well as transmit the same alternately coded to the primary side. This creates a further anti-tampering barrier, because, in order to achieve an inductive coupling operation for the purpose of coupling to the coil on the side of the leaf/sash, the resistance value would also have to be known, and the corresponding signal would have to be generated.

The query value of the control resistance can be transmitted to the first coil by modulating the carrier voltage that is in effect on the second coil; after this step, it is compared to a set value. A second disruption signal, for example, can then be used for triggering an alarm if the detected value exceeds a certain, still allowable, differential amount relative to a reference value. Experiments have shown that, in order to reduce the risk of triggering a false alarm, the differential amount of approximately 40% of the resistance value is a well suited threshold value.

To render any chance at tampering substantially more difficult, even if the person planning to commit an act of sabotage knows the resistance value, encrypted control signals and response control signals can, for example, be applied to the first and the second coils.

The possibility that unauthorized persons decrypt any information is rendered even more difficult when, for example, the control signal and the response control signal are encrypted with the aid of an alternating code.

To improve security against tampering even further, the method can comprise the method step of a mutual authentication of a primary electronics means, which is electrically connected to the first coil, and a secondary electronics means, which is connected to the second coil.

The apparatus for implementing the previously described method comprises a first coil, which is provided on a wall, a second coil, which is provided on a door leaf/window sash, wherein the first and the second coils are disposed in an inductive operative connection, a primary electronics means, which is connected to the first coil, and a secondary electronics means, which is connected to the second coil, wherein the primary and the secondary electronics means comprise means for generating and detecting control signals and response control signals.

The secondary electronics means can, for example, comprise means for modulating a carrier voltage with the control signals, for example, an amplitude modulator. The primary electronics means can, for example, also comprises means for modulating a carrier voltage with the response control signals, for example, a frequency modulator.

Means for authenticating the primary and secondary electronics means can, for example, also be provided.

In order for the primary and secondary electronics means to be accessible only by a destructive effort when the door leaf/window sash is closed, the primary and secondary electronics means each comprise a housing that is suitable for installation inside a profile of the frame or in a leaf/sash, for example, inside profile cutouts on the sides that are directed toward each other when the leaf/sash is closed.

To avoid interferences on the primary or secondary electronics means, on the one hand, caused by external electrical magnetic fields, while avoiding, on the other hand, leakage of electromagnetic radiation from the housings, said housings can, for example, be configured with a shielding.

To prevent overheating of the electronic components that are provided in the housing, which themselves regularly generate a certain amount of heat, the housings can, for example, be produced from a heat-conducting material. For example, from a heat-conducting plastic material for reasons of simplification of the production.

The primary and the secondary electronics means can, for example, furthermore comprise modems for 8 bit coding and decoding of signals and control signals that are transmitted. With the aid of these modems, it is possible to modulate and then transmit, interference-insensitively, analog signals, which are transmitted, for example, by the means and sensors provided on the leaf/sash. The primary and the secondary electronics means can further each comprise a BUS system that is able to accommodate a plurality of sensors, respectively. The transmission of the measured values or operating states, that are provided by means of the sensors, can then occur serially following modulation and demodulation, for example using protocols that are compliant, for example, with the RS 485 standard.

The apparatus, which is designated as a whole by the reference numeral 100 in the drawing, optically emulates a so-called three-piece hinge flap. If required, the construct can have a carrying hinge-type function at the same time and is, therefore, able to replace a conventional hinge flap. The apparatus can alternatively serve only for the contactless transmission of electrical energy and/or electrical signals while being provided as a supplement in addition to conventional hinge flaps on hinge flap-leaf/sash apparatus.

The apparatus 100 comprises a component/hinge flap part 1 that serves for the fastening to a stationary frame R. Included are two hinge parts 2, 2′ that are spaced relative to each other in the longitudinal direction of a hinge axis S and about a spacing area 3.

The hinge part 4 of a leaf/sash part 5 is disposed inside the spacing area 3 between the top hinge part 2 and the bottom hinge part 2′ and fastened, as shown in the embodiment that is depicted in the drawing, on a leaf/sash frame F. For the mounting step, the hinge flap part 1 comprises the hinge flap fastening parts 6, 6′ and the leaf/sash part 5 a leaf/sash fastening part 7.

The hinge axis S is defined by the hinge bolt 8, which traverses the hinge parts 2, 2′ and 4 inside hinge bolt receptacles, which are not shown in further detail in the drawing in an effort to provide for an easy comprehension of the drawing.

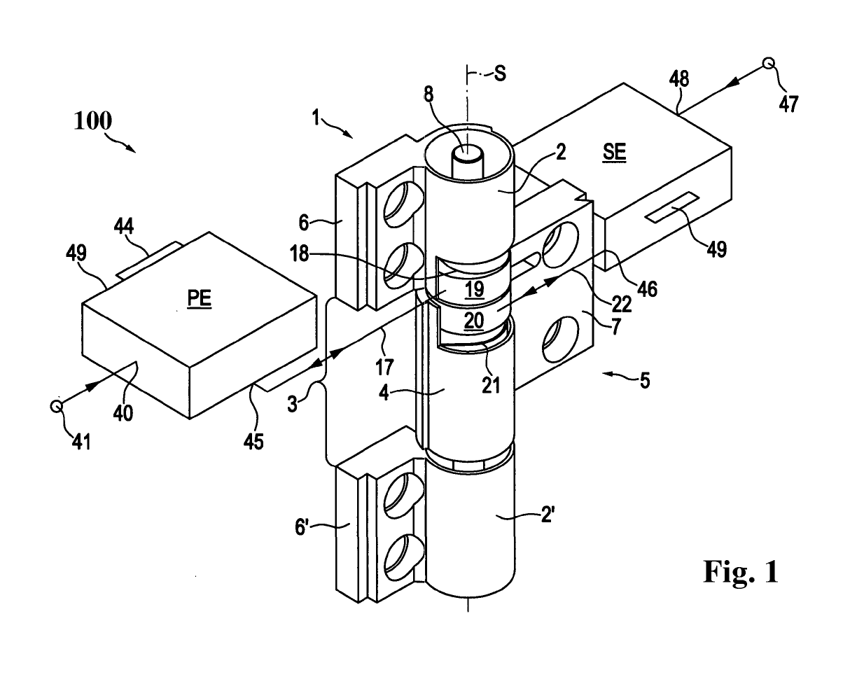

A first (electrical) coil 19 is provided in the top hinge part 2 of the hinge flap part 1, which has a load applied thereto by a helical spring 18 having a spring force that is in effect in a downward direction according to FIG. 1. The first coil 19 is connected, with the aid of an at least two-wires, for example, shielded electrical line 17, to a primary electronics means PE.

A second (electrical) coil 20 is inserted in the hinge part 4 of the leaf/sash part 5, which has a load applied thereto by a helical spring 21 having a spring force that is in effect in the upward direction according to FIG. 1. The first and second coils 19, 20 are disposed against each other, subject to the effect of the helical springs 18, 21.

The second coil 20 is connected, via an at least two-wires, for example, shielded electrical line 22, to a secondary electronics means SE.

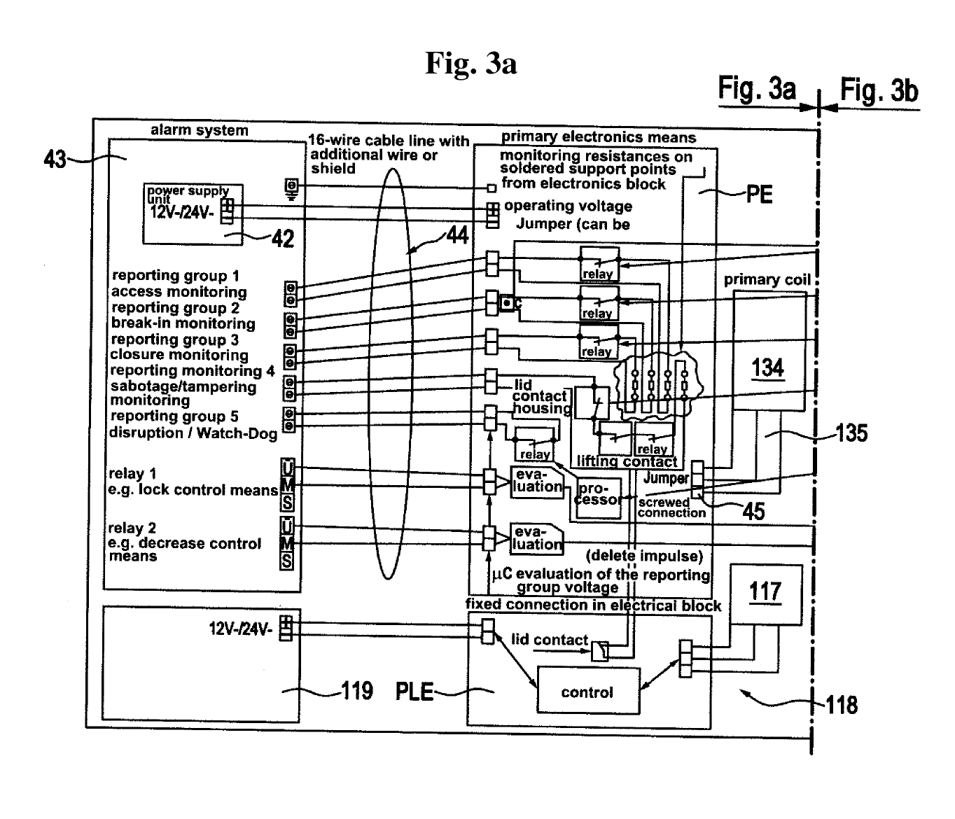

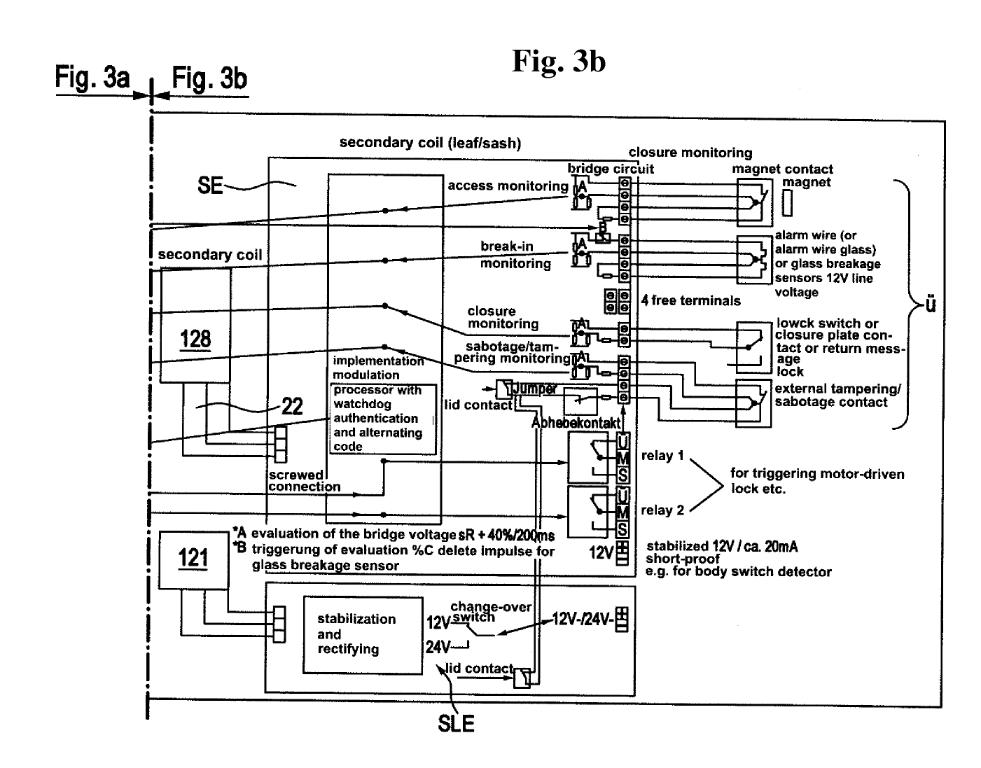

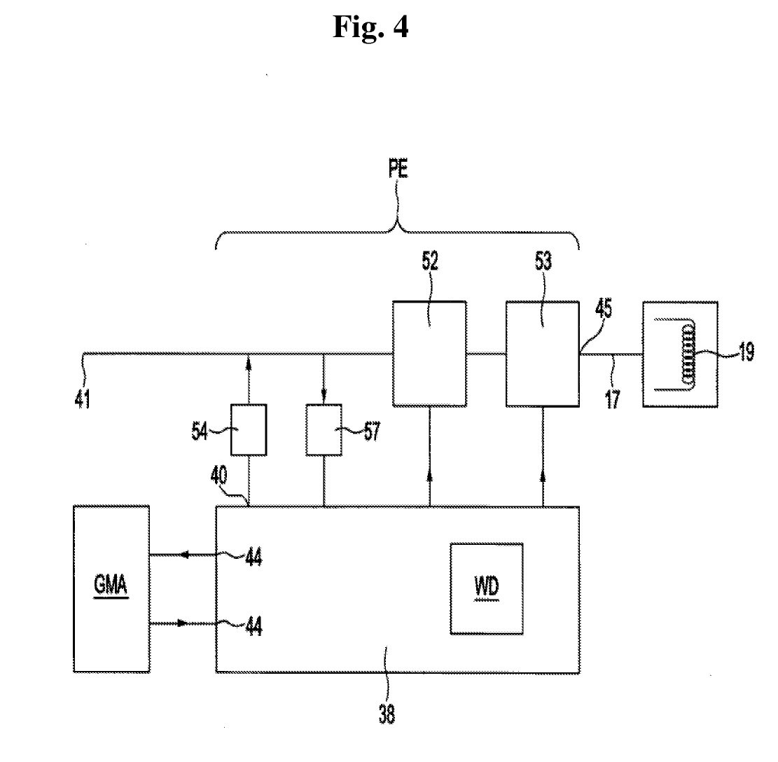

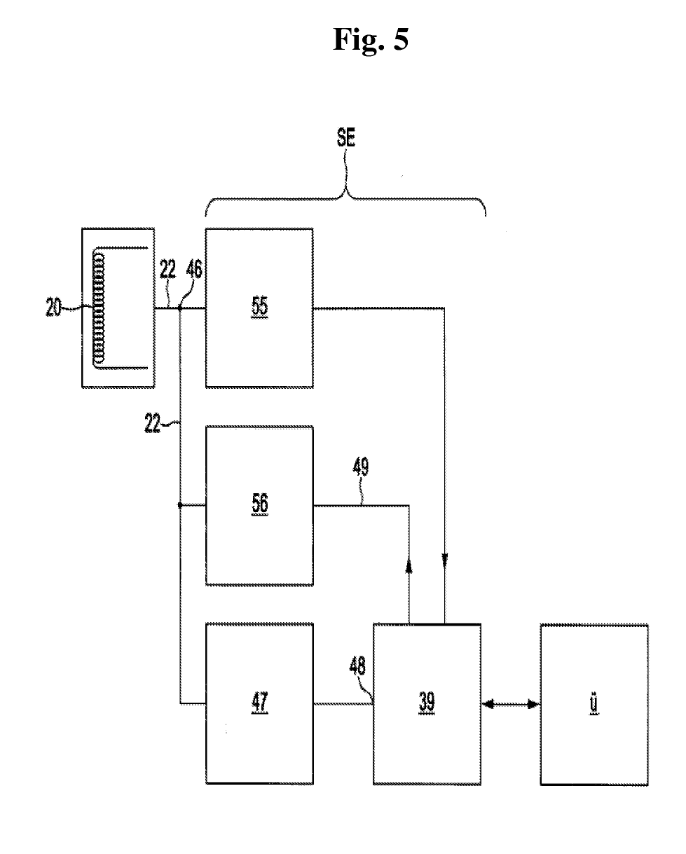

The primary electronics means PE (FIG. 4) includes a primary processor 38 with an input 40, which serves for the connection to an energy supply source 41, via a switching controller 54 that converts the voltage provided by the energy supply source into an operating voltage of the primary processor. The same can be, as seen in FIG. 3, an emergency-current-buffered output of a power pack 42 of an alarm system 43. Provided is a supply direct voltage of, for example, 13.8V. The primary electronics means PE comprises an AC-DC inverter 52 that converts the input direct voltage into a suitable alternating voltage that can be applied to the first coil 19, for example of 12V, and a carrier frequency of 40 kHz.

The primary processor 38 includes the connections 44a, 44b to which are applied, for example, signals from the monitoring of access, breach, closure as well as sabotage and tampering actions, as well as control signals such as, for example, for the lock actuation of an alarm system GMA. The primary electronics means PE converts these control signals with the aid of a BUS system standard into serial datasets using, for example, protocols that are compliant with the RS 485.

The primary processor 38 also comprises a watchdog means WD that monitors the functions of the primary and secondary electronics means, as well as of the components and systems that are connected thereto. Any detected malfunction is signaled as a malfunction to the alarm system to avoid triggering a false alarm, when such a malfunction occurs. The watchdog WD is moreover able to initiate program instructions by the primary processor 38 for remedying the problem.

The primary electronics means PE further comprises a modulator 53 that is used to modulate the carrier frequency by the datasets that is transmitted. The modulated carrier voltage is applied to a connection 45 and is routed to the first coil 19 via the electrical line 17.

A secondary voltage is induced in the second coil 20 and routed to a connection 46 of the secondary electronics SE via the electrical line 22. The same comprises a demodulator 55, which demodulates the secondary voltage that was modulated by the signals and transmits the signals to a secondary processor 39, for example, a monitoring means Ü for monitoring access, break-in, closing or sabotaging and tampering activities. Sensors and means Ü for status queries and actuation are connected to the secondary processor via in/out lines.

The secondary processor 39 is connected to an energy supply source 47, which provides, for example, 12V of direct voltage at an input 48. The energy supply of the secondary electronics means is achieved, correspondingly, by means of a supply voltage that is generated in the second coil 20 by induction.

The secondary electronics means SE again comprises a modulator 56 that converts signals provided via connections 49 by the sensors of the aforementioned monitoring means in serial signal packets in such a manner that is compliant with the primary electrics means PE. The thus modulated carrier voltage is applied to the second coil 20 via the electrical line 22. The alternating voltage that is thus induced in the first coil 19 is supplied via the electrical line 17 of the primary electronics means PE and demodulated therein in a demodulator 57, then supplied via the connections 44 of the alarm system GMA.

To generate a signal transmission that is as insensitive to disruption as possible and has minimal signal leakage, the data that is transmitted from the primary side to the secondary side are frequency-modulated, and the data that is transmitted from the secondary side to the primary side, are amplitude-modulated.

The bidirectional data transmission that is thus achieved occurs with 8 bit resolution and a transfer rate of, for example, 9600 baud.

To improve protection against sabotage and tampering further, the secondary electronics means SE transmits a control signal packet at 200 ms time intervals via the electrical lines 22 and 17 as well as the second and first coils 20 and 19 to the primary electronics means PE. The receipt of the control signal packet is confirmed by a return transmission of a response control signal packet to the secondary electronics means SE within a 40 ms time interval. If the secondary electronics means SE receives no response control signal within this time interval, another control signal packet is transmitted to the primary electronics means PE. If the primary electronics means PE does not receive any control signal packet within the 200 ms time interval, the disruption signal is generated. The same occurs if two consecutive control signal packets were defective.

To improve protection against sabotage and tampering even further, the secondary electronics means SE emulates and queries a control resistance on the leaf/sash side which is then compared to a reference value deposited in the secondary electronics means. If the transmitted measured value deviates, for example, by 40% from the set value, this information is evaluated as an indication of attempted sabotage or tampering. The result of this comparison is transmitted to the primary electronics means PE during this time interval.

The control and response control signal packets are encrypted to further improve security using an alternating code that can be decrypted by the respective receiving primary electronics means PE and/or the secondary electronics means SE.

A corresponding signal is generated at the connection (output) 44.

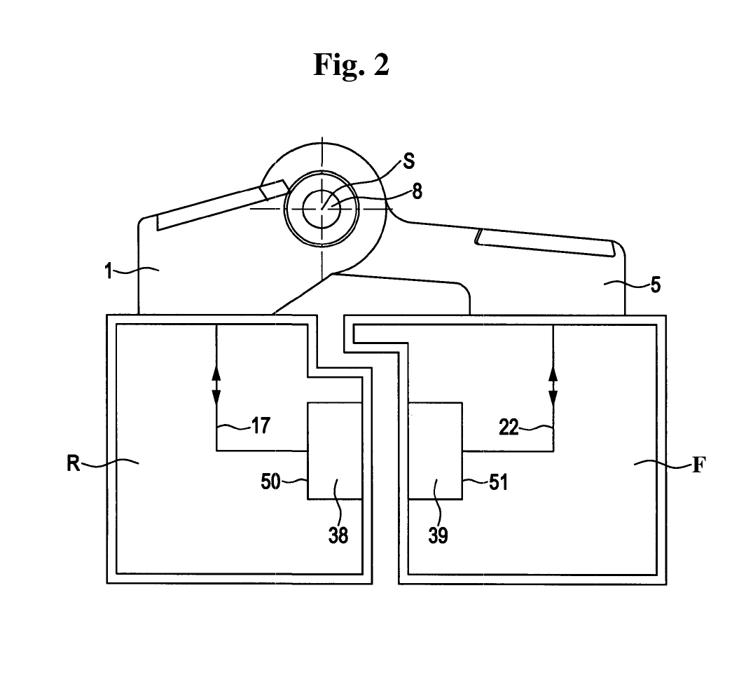

The primary electronics means PE and the secondary electronics means SE are accommodated inside resilient housings 50, 51 with good heat conductivity; these are shown in a schematic depiction only shown in FIG. 2.

The housing 50 of the primary electronics means PE is mounted inside a frame profile on the wall side; housing 51 of the secondary electronics means SE is mounted inside a leaf/sash profile. The installation occurs, as can be derived from FIG. 2, from the profile sides, which are oriented toward each other when the leaf/sash is closed. The housings 50, 51 are in this way not visible from the outside and can be protected against tampering and sabotage, because any attempt at removal generates an alarm and/or disruption signal.

To improve the security against sabotage and tampering even further, the primary electronics means PE and the secondary electronics means SE are provided with means for mutual authentication, such that any unnoticed exchange of a primary or secondary electronics means PE, SE by an electronics means that was previously tampered with is rendered substantially more difficult.

To increase the security against sabotage and tampering even further, the housings of the electronics means are provided with lid sensors and/or lifting sensors. If said sensor detect that a housing is opened and/or lifted, such an incidence is evaluated as an attempt indicating sabotage or tampering, and a corresponding signal is generated at output 44.

The preceding embodiment of the apparatus according to the present invention serves, first and foremost, for the purpose of signal transmission. The electrical power that is needed for operating the secondary electronics means is also created by induction in the secondary coil. Higher electrical power values are, however, regularly needed for actuating the devices on the secondary side than can be induced by the primary coil in the secondary coil, while still maintaining signal transmission. In that case, a separate electrical power supply is needed for actuating the devices on the secondary side.

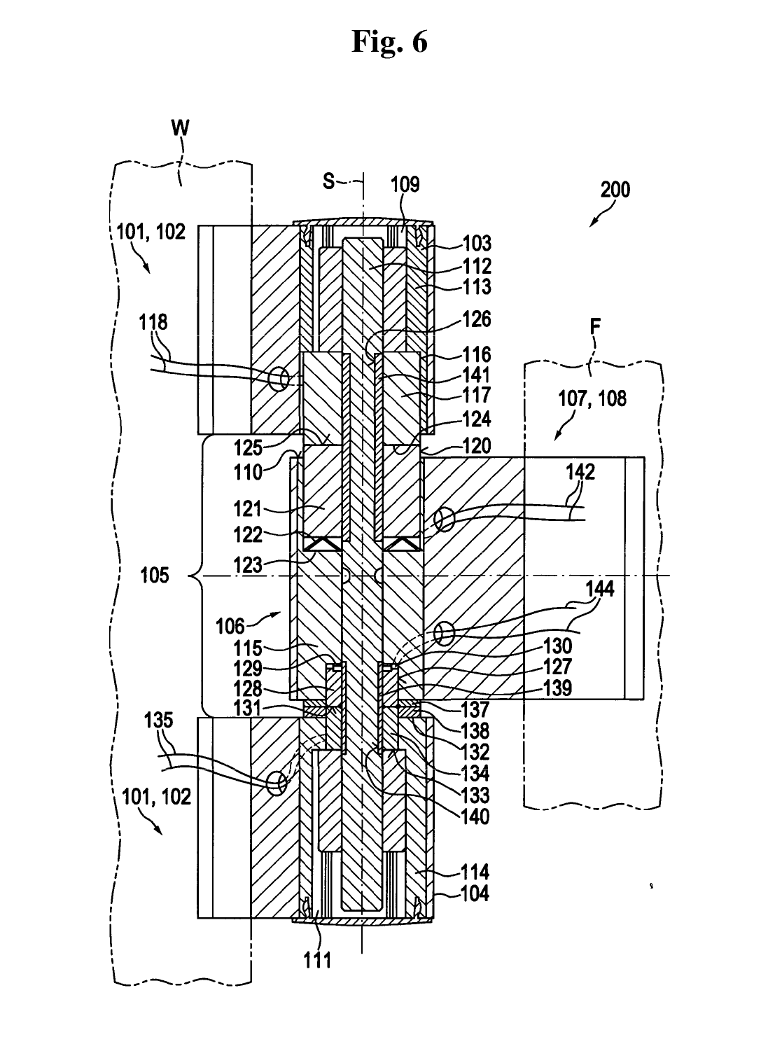

In the embodiment as shown in FIG. 6 et seq., referenced overall by the numeral 200, this electrical power supply is also provided by inductive coupling. This device 200 is configured as a so-called three-piece hinge flap. It comprises a frame hinge flap 101, that constitutes a hinge flap part 102 of the apparatus 200, and that serves for fastening the same to a stationary wall W or a stationary frame, respectively. The frame hinge flap 101 includes two hinge parts 103, 104 that are disposed at a distance relative to each other in the longitudinal direction of the hinge axis S by a spacing area 105.

Between the top hinge part 103 and the bottom hinge part 104, inside the spacing area 105, there is disposed the hinge part 106 of a leaf/sash hinge flap part 107, which forms a leaf/sash part 108 in the shown embodiment that can be fastened, as shown in the drawing, to the leaf/sash F.

The hinge axis S is defined by a hinge bolt 112 that traverses the hinge parts 103, 104 and 106 in the bolt receptacles 109, 110 and 111. It is perpendicularly adjustable in the known manner relative to the hinge axis S inside the hinge bolt receptacles 109, 111 of the hinge parts 103, 104 of the frame hinge flap part 101, it is and supported with the aid of the bearing bushes 113, 114 that are manufactured of a plastic material.

A bearing bush 115 is provided for supporting the hinge bolt 112 in the hinge bolt receptacle 110 of the leaf/sash hinge part 106, which is also manufactured of a plastic bearing material.

The bearing bush 113 of the top frame hinge part 103 includes in the area thereof that is directed toward the leaf/sash hinge part 106 a recess/cutout 116, which is rotationally symmetrical around the hinge axis S and into which an electrical primary power coil 117 is inserted. It is connected, with the aid of two electrical connection cables 118, to a power voltage supply 119 (see FIG. 3).

The bearing bush 115 of the leaf/sash hinge part 106 comprises on the side that is oriented toward the primary power coil 117 also a recess/cutout 120, into which a secondary power coil 121 is fitted that has a structural design corresponding to that of the primary power coil 117.

The secondary power coil 121 is displaceably supported in a recess 120 in the direction of the hinge axis S, supporting itself against the floor 123 of the recess 120 by means of a spring element 122 such that the frontal sides 124, 125 of the primary and the secondary power coils 117, 121, which are oriented toward each other, come to rest against each other.

The primary and secondary power coils 117, 121 have an outside diameter that corresponds to the internal diameter of the bolt receptacles 113, 115. This way, it is possible for the primary and secondary power coils 117, 121 to optimally utilize the cross-sectional area that is defined by the dimensions of the top frame hinge part 103 and the leaf/sash hinge part 106 in order to thereby maximize the electrical power that can be inductively transmitted from the primary power coil 117 to the secondary power coil 121.

To further improve the coupling action of the primary and secondary coils 117, 121, the hinge bolt 112 includes a waist 126 over the length thereof over which the same is covered up by the primary and secondary power coils 117, 121. A sleeve core 141 comprised of two semi-shells that are made of a sintered ferrite material, for example, on the basis of manganese-zinc-ferrite powder, is incorporated in the waist 126. The hinge bolt 112 that comprises the sleeve core 141 thus serves as a body for conducting the magnetic flow.

In the area of the leaf/sash hinge part 106, which is disposed opposite the secondary power coil 121, a further cutout 127 is incorporated in the bearing bush 115, which is also symmetrical relative to the hinge axis S. It serves for receiving a signal transmission coil 128, which is also referred to as the “second coil”. The signal transmission coil 128 is, in turn, displaceably received in the direction of the hinge axis S inside the cutout 127, supporting itself against the floor 129 with the aid of a spring element 130.

The signal transmission coil 128 rests by the frontal side 131 thereof, which is opposite the spring element 130, against a frontal side 132 of a further signal transmission coil 134, which is supported in a corresponding cutout 133 and also referred to as the “first coil”. The signal transmission coil 134 is connected to a primary electronics means PE by means of the connection cables 135, and the signal transmission coil 128 is connected by means of cables 144 to secondary electronics SE (see FIG. 3). The operation and the structural design of the signal transmission coils and of the primary and secondary electronics means PE, SE correspond to those as outlined with regard to the apparatus 100.

Slide discs 137, 138 are provided between the bottom frame hinge part 104 and the leaf/sash hinge part 106 serving to reduce wear and tear caused by the pivoting actuation of the hinge.

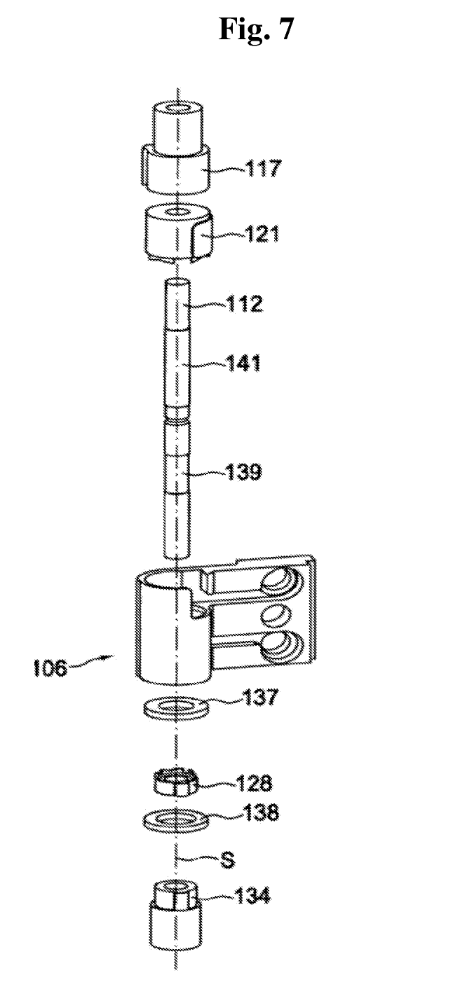

As discernable particularly in FIGS. 6 and 7, the signal transmission coils 128, 134 are dimensioned visibly smaller than the primary and secondary power coils 117, 121, because smaller coil volumes are sufficient for the signal transmission. The sleeve 139, that is comprised of the two semi-shells made of a sintered ferrite material on the a manganese-zinc-ferrite powder basis, which is provided in the cover-up area of the signal transmission coils 128, 134, is provided in a waist 140 of the hinge bolt 112 and has a considerably smaller wall strength than the sleeve core 141, such that overall the area of the signal transmission coils is suited for transmitting larger mechanical forces between the wall and/or frame and leaf/sash than the area of the primary and secondary power coils 117, 121. The configuration of the apparatus 200 having two separate pairs of coils for the transmission of power and signals is therefore in and of itself significant in terms of involving an inventive step.

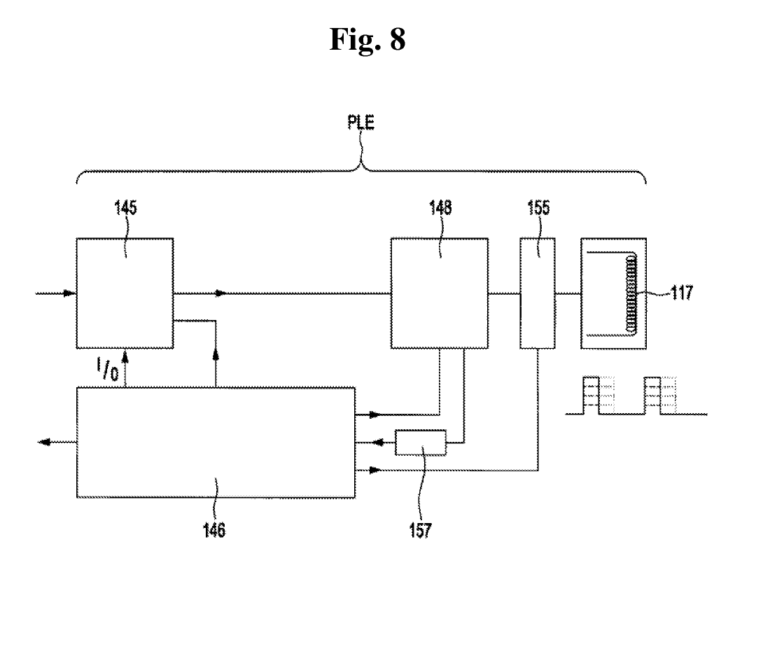

A power voltage supply of an alarm system provides a power direct voltage of 12V or 24V. It is applied to a switching controller 145 that converts this voltage into a suitable supply voltage for generating a needed secondary power voltage. The value is between 12V and 48V. Disposed downstream of the switching controller 145 is an AC-DC inverter 148 that is also connected to the primary power processor 146. The AC-DC inverter 148 converts the output voltage of the switching controller 145 into a, for example, rectangular alternating voltage that can be applied to the primary power coil 117; in the shown embodiment, this is 12-22V with a frequency of 40 kHz, being applied via an on/off switch 155 to the primary power coil 117. Approximately a corresponding secondary power voltage is induced in the secondary power coil 121 (aside from transmission losses and phase shifts) that is supplied via cables 142 (also referred to as a line) to a secondary power electronics means SLE (see FIG. 3). To be able to vary the power that is induced in the secondary power coil 121, it is possible (as symbolized in FIG. 8) to adjust the value of the primary power voltage in four steps and the pulse values gradually in a stepless manner. The current that flow through the primary power coil is detected by a current measuring device 157, and the measured value is supplied to the primary power processor 146. It comprises a data storage unit where the transmission characteristic, meaning the dependent relationship of the power that can be obtained at the secondary coil is stored as a function of the power that is supplied to the primary power coil, and from which the secondary power value, which belongs to a certain primary power value, can be inversely retrieved.

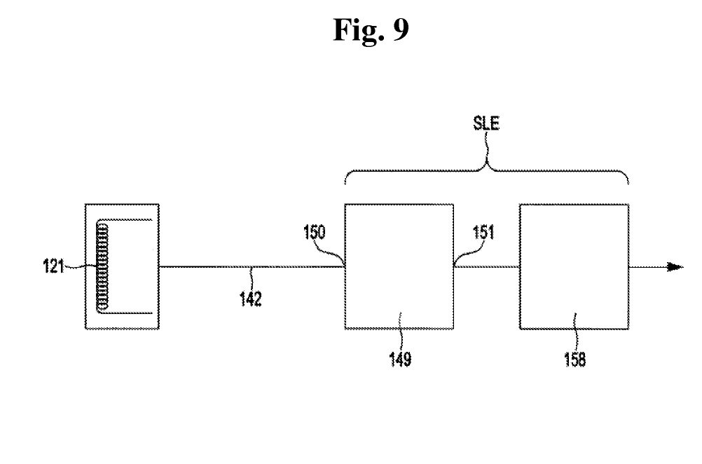

The secondary power voltage is applied to the input 150 of a rectifier 149 that has, at the output 151, a power direct voltage serving for actuating the device on the secondary side in or on the leaf/sash (see FIG. 9). Disposed downstream of the rectifier 149 is a voltage-limiting means 158 that limits the voltage, which is induced in the secondary power coil, to a maximum voltage that is preset by the consumer disposed downstream.

Due to the transmission characteristic that are stored in the data storage unit, which is experimentally determined, for example, by measurement series on the device, it is known what power must be applied to the primary power coil 117 in order to be able to extract a certain power from the secondary power coil 121. The current that flows through the primary power coil 117 is measured with the aid of the current measuring means 157, and the measured value is supplied to the primary power processor 146. Said processor determines, by accessing the data deposited in the data storage, the secondary power that is associated with a detected current value and the known primary voltage.

If no secondary voltage is requested, the secondary current circuit is therefore open, and only the leaked current is measured on the primary side. The voltage that is applied to the secondary output is known from the transmission characteristic that are deposited in the data storage. If the power demand on the secondary side increases, this will result in an increase of the primary current. The primary power processor 146 then triggers the DC-AC inverter 148 in such a manner that the maximum power is transmitted. Correspondingly, with the activation, the maximum power is immediately available on the secondary side, which is why start-up delays that are an issue on motor drives, for example, are avoided. The maximum secondary power is generated by increasing the primary voltage to the maximum value and adjustment of the maximum pulse width. Voltage values on the secondary side that may be too great for the respective consumer are blocked by means of the voltage-limiting means 158. Correspondingly, only that current flows on the secondary side (and therefore also on the primary side) that the consumer in fact requires. By means of the primary current measurement, which is detected with the aid of the current measuring means 157, the primary power processor 146 controls the power by reducing the primary voltage and/or the pulse width until, according to the transmission characteristic as deposited in the data storage, the necessary secondary power that the consumer requires must be present.

The present invention is not limited to embodiments described herein; reference should be had to the appended claims.

### LIST OF REFERENCE SYMBOLS

100 Apparatus
1 Hinge flap part
2,2′ Hinge parts
3 Spacing area
4 Hinge part
5 Leaf/sash part
6,6′ Hinge flap fastening parts
7 Leaf/sash fastening part
8 Hinge bolt
17 Electrical line
18 Helical spring
19 First coil
20 Second coil
21 Helical spring
22 Electrical line
38 Primary processor
39 Secondary processor
40 Input
41 Energy supply source
42 Power pack
43 Alarm system
44 Connections
45 Connection
46 Connection
47 Energy supply source
48 Input
49 Connections
50 Housing
51 Housing
52 AC-DC inverter
53 Modulator
54 Switching controller
55 Demodulator
56 Modulator
57 Demodulator
F Leaf/sash frame
R Frame
S Hinge axis
PE Primary electronics means
GMA Alarm system
SE Secondary electronics means
Ü Sensors and means/Monitoring means
200 Device
101 Frame hinge flap
102 Hinge flap part
103 Hinge part
104 Hinge part
105 Spacing area
106 Hinge part
107 Leaf/sash hinge flap part
108 Leaf/sash part
109 Bolt receptacle
110 Bolt receptacle
111 Bolt receptacle
112 Hinge bolt
113 Bearing bush
114 Bearing bush
115 Bearing bush
116 Cutout
117 Primary power coil
118 Connection cable
119 Power voltage supply
120 Cutout
121 Secondary power coil
122 Spring element
123 Floor
124 Frontal side
125 Frontal side
126 Waist
127 Cutout
128 Signal transmission coil
129 Floor
130 Spring element
131 Frontal side
132 Frontal side
133 Cutout
134 Signal transmission coil
135 Connection cable
137 Slide disc
138 Slide disc
139 Sleeve
140 Waist
141 Sleeve
142 Cable
144 Cable
145 Switching controller
146 Primary power processor
148 AC-DC inverter
149 Rectifier
150 Input
151 Output
155 Switch
157 Current measuring device
158 Voltage-limiting means
F Leaf/sash
S Hinge axis
Ü Sensors and means/Monitoring means
W Wall
WD Watchdog
PLE Primary power electronics means
SLE Secondary power electronics means

What is claimed is:

1-5. (canceled)

6. A method for a contactless transmission of electrical energy between a wall and a door leaf/window sash fastened to the wall in an articulated fashion via hinges about a hinge axis, the method comprising:
providing a primary power coil fastened to the wall;
providing a secondary power coil fastened to the door leaf/window sash, the primary power coil and the secondary power coil being configured to be in an inductive operative connection with each other;
measuring an electrical primary current flowing through the primary power coil so as to obtain a measured value;
supplying the measured value to a primary power electronics device which is configured to store a transmission characteristic as a function of a power available at the secondary power coil in dependence on a primary power supplied to the primary power coil;
applying a maximum provided power to the primary power coil when an electrical primary current increases;
limiting a secondary power voltage induced in the secondary power coil to a preset maximum value; and
measuring a primary current and, based on the measured primary current, reducing a power applied to the primary power coil until a required power, which is stored according to the transmission characteristic of the secondary power coil in the primary power electronics device, is induced.

7. The method as recited in claim 6, wherein a change of the power applied to the primary power coil is effected by varying a primary voltage and a pulse width of the primary voltage.

8. The method as recited in claim 7, wherein the pulse width of the primary voltage is a rectangular alternating voltage.

9. An apparatus for a contactless transmission of electrical energy between a wall and a leaf/sash fastened to the wall in an articulated fashion via hinges about a hinge axis, the device comprising:
a primary power coil configured to be fastened to the wall;
a secondary power coil configured to be fastened to the leaf/sash;
a primary power electronics device configured to store a transmission characteristic as a function of a power available at the secondary power coil in dependence on a primary power supplied to the primary power coil;
a current measuring device configured to measure a current that flows in the primary power coil so as to obtain a measured value which is suppliable to the primary power electronics device;
a primary power influencing device configured to influence the primary power applied to the primary power coil; and
a voltage-limiting device configured to limit a secondary voltage value generated by induction in the secondary power coil to a preset maximum voltage value.

10. The device as recited in claim 9, wherein the primary power influencing device comprises at least one of a switching controller and an AC-DC inverter comprising a pulse width modulator.

11. The device as recited in claim 9, further comprising a rectifier, the rectifier being configured to convert a secondary power voltage induced in the secondary coil to direct voltage.
